(19) United States
(12) Patent Application Publication
(10) Pub. No.: US 2007/0226152 A1
(43) Pub. Date: Sep. 27, 2007

(54) SYSTEM AND METHOD FOR ANONYMOUS TRANSACTIONS AND CONVEYANCES

(76) Inventor: Austin Jones, Phoenix, AZ (US)

Correspondence Address: VENABLE, CAMPILLO, LOGAN & MEANEY, P.C., 1938 E. OSBORN RD, PHOENIX, AZ, 85016-7234, US

(21) Appl. No.: 11/277,214

(22) Filed: Mar. 22, 2006

Related U.S. Application Data
(63) Continuation of application No. 11/277,081, now abandoned.

(51) Int. Cl. H04L 9/00

(52) U.S. Cl. 705/74

(57) ABSTRACT

A system and associated methods enabling a customer or transferee to acquire a product or service from a merchant, vendor or transferor through the services of an intermediate entity using a transaction protocol that shields the customer's name or other identifying information from the intermediate entity, the merchant, vendor or transferor, the delivery agent, and other agencies that may be ancillary to the transaction. The system and method is also useful for allowing anonymous sales from a seller to a buyer and conveyances from a transferor to a transferee.

This application is a continuation of U.S. patent application Ser. No. 11277,081 filed 21 Mar. 2006.

### BACKGROUND OF THE INVENTION

1. Field of the Invention

The invention is applicable in the field of methods or systems for transacting for goods or services.

2. Discussion of the Related Art

Individual privacy is a growing concern given that merchants are increasingly engaged in the compilation of the personal information of customers for either private use or for sale. Moreover, despite that a merchant can and will covenant against the use or sale of customer information for other than approved uses, merchant databases have been and will be compromised by third parties (e.g. hackers) or disgruntled employees and customer personal or identifying information may be disclosed without customer consent. Accordingly, many potential customers disapprove of having their personal information compiled by merchants. The related art discloses systems and methods with limited utility addressing this problem.

U.S. Patent Application No. 20020099667 by Diamandis et al. (“Diamandis '667”) and U.S. Patent Application No. 20010037209 by Tarbutton et al. (“Tarbutton '209”) each disclose use of a prepaid payment card to enable a customer to anonymously interact directly over the Internet with a merchant to make purchases. While use of a distributed network may be desirable in some instances and for some people, not everyone wishes to use the Internet as a medium to transact for goods and services. Some avoid the use of the Internet for fear that a third party (e.g. a hacker) will intercept their communications or learn their identity to engage in fraudulent activity. Thus, some customers are required to conduct in-person transactions when they would rather not transact directly with the merchant at its place of business. It follows that some may avoid beneficial or desired transactions to avoid in-person transactions and preserve their anonymity. Accordingly, there is a need for a system and methods to anonymously purchase goods and services and that avoids use of the Internet or that engages in modest use of the Internet while employing techniques to reduce the potential for fraud or identity theft.

### SUMMARY OF THE INVENTION

Aspects of the invention are summarized below to aid in the understanding of embodiment(s) of the invention and the application. Yet, the invention is fully defined by the claims of the application.

The invention is a system and associated methods which, in the preferred embodiment, enables a customer to purchase or transfer a product or service from a transferor or merchant using an intermediate entity and a transaction protocol that shields the customer's name or other identifying information from the intermediate entity, the merchant, the delivery agent, and other agencies that may be ancillary to the transaction. The system and method enables anonymous purchases, sales, or non-commercial transfers from a seller, buyer or transferee, respectively. In each embodiment, the buyer and/or seller can optionally select the degree of anonymity desired.

### BRIEF DESCRIPTION OF THE DRAWINGS

FIG. 1 illustrates that the ultimate consumer, customer, purchaser, or recipient (“CTM”) identifies a specific good or service desired from a merchant, vendor, seller, or other transferor (“TR”) and interacts with an intermediate entity (“IE”) to indirectly acquire the good or service using a unique transaction code (“TC”). FIG. 1 also illustrates that the method and system embodiment may be wholly or partially implemented using a distributed network such as the Internet (i.e. “online”) or may be implemented using elements familiar to traditional transacting methods such as mail, facsimile or the like.

FIG. 2 illustrates that the IE transacts with the TR entity using a separate purchase order code (“POC”) rather than the transaction code (“TC”) to acquire the CTM's desired good or service, and also that the IE delivers the good or service to the CTM according to the CTM's previously communicated directions.

FIG. 3 illustrates the CTM's collection or receipt of the good or service or alternatively additional steps that the IE can process should the CTM reject the good or service.

FIG. 4 illustrates an exemplary state or flow diagram and creation of a CTM account.

FIG. 5 illustrates use of the transaction code to check the balance of a CTM account associated with the transaction code.

### DESCRIPTIONS OF EMBODIMENTS

This invention is a system and associated methods or processes that enable a CTM to transfer or purchase a good or service from a TR using the services of an IE administering a transaction protocol described herein. The transaction processing or protocol described herein shields or protects the CTM's name or other identifying information from the entities in the transaction; including the IE, the TR, the delivery agent, the transferor, and/or other agencies that may be ancillary to the transaction. Thus agents (e.g. distributors, resellers, or brokers) transacting on behalf of a TR are shielded or deterred from determining the CTM's identity. For the purposes of this description, the CTM may be an individual person or an entity, and the good or service may be of either a tangible or a digital form. The CTM may optionally waive anonymity for one or more ancillary agencies. Thus, the CTM may arrange for payment of goods or services using trusted financial agents who may know the identity of the CTM but which covenant not to disclose the CTM to the IE.

The carrier or delivery agent for tangible merchandise may be an entity such as USPS or FedEx; for digital merchandise, the delivery agent may be an electronic entity on the Internet. While the IE can receive payment directly from the CTM, other agencies may also be involved, such as credit card issuers, anonymizers, digital cash entities, banks, postal departments, etc., in all such cases, the CTM's identity is protected, just as if the IE alone were engaged in the transaction with the TR.

Embodiments of the system include the use of a first unique code and an IE that acts as an agent to acquire the good or service for the benefit of the CTM using only the first unique code to identify that transaction. Thus, for each transaction, the first unique code establishes a communication identity that is unique to that transaction and functions as a transaction identifier or a transaction code (“TC”). The TC implemented in the described system allows the CTM and IE to identify interactions associated with a particular anonymous transaction. Interactions between the CTM and the IE include, but are not limited to, communications conveying contract negotiation information such as offer, acceptance, assent, consideration, proposed terms, formation and/or acknowledgment of performance of a particular transaction.

For ease of use by CTMs and the IE, preferred implementations of the system realize the system or transaction protocol with coordinated materials that are transferable in commerce and associated with a particular TC. The coordinated materials are conveyed to and from the CTM and IE using most available means of communication. Further, the coordinated materials may be communicable to the CTM and/or IE in hard copy printed materials or electronically communicable depending on CTM means and desire. Thus, the coordinated materials may be conveyed to the CTM by retail, electronic mail, facsimile, or mail carrier. The coordinated materials comprise one or more instances of transaction media comprising at least one form permitting the CTM to communicate with the IE and identify particular terms of a desired transaction such as the good or service to be purchased, the identity of the TR, and other terms of the proposed contract or transaction.

A preferred format for the transaction media comprises at least one form or preferably a collection of preprinted forms. The form or forms may be sealed within a tamper-resistant container (e.g. tamper-resistant envelope) and preprinted with instructions and entry blanks wherein the CTM can input the terms of the offered transaction and the preferred TR. The collection of forms used with the anonymous transaction protocol will be referred to as a customer order packet (“COP”) for the sake of brevity. A CTM desiring to make an anonymous transfer, acquisition, or purchase will obtain such a packet. The form or forms within the packet are associated with a TC unique to that COP.

The TC can take on many different forms and formats depending on the desired level of security, such as symbols and/or alphanumeric characters and hence the term TC is intended to be non-limiting as to form and format. In one embodiment, the TC consists of an alphanumeric that is preprinted on a CTM order form included in the COP. A CTM order form is one instance of transaction media in the set of the coordinated materials accompanying the packet and on which the CTM conveys terms of the offered transaction. Other materials included in the packet include additional instances of the transaction media such as copies of the TC or alternate related derivations of the TC printed on tamper resistant media.

In one preferred embodiment, the CTM order form has entry areas or blanks on which the CTM can communicate terms of the desired transaction to the IE. Exemplary transaction terms include: (1) the name and/or description of the good or service to be purchased; (2) the name(s), address(es), and telephone number(s) of the preferred TR(s); (3) the price and the price limit the CTM is willing to pay, in the event the price is found to be greater than indicated by the CTM; (4) the maximum acceptable time within which the CTM is willing to receive the good or service; (5) the method(s) and terms by which the CTM authorizes the IE to communicate with it; and (6) the manner in which the CTM elects to receive delivery of the good or service.

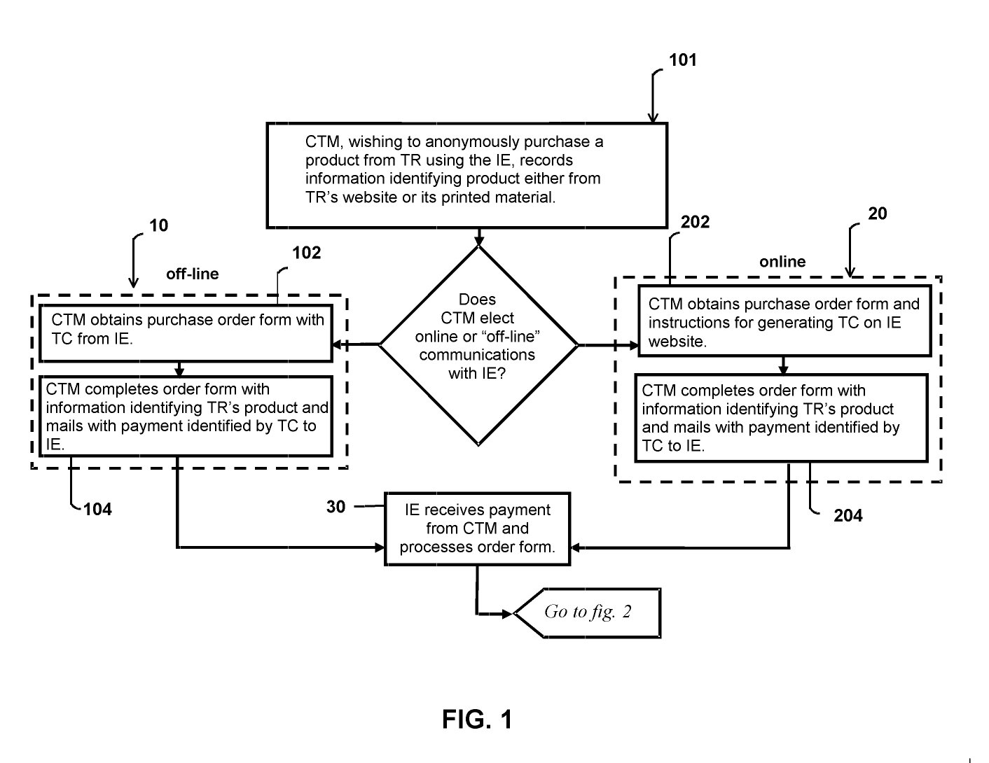

FIG. 1 illustrates an exemplary flow diagram and possible embodiments of a CTM's online 20 or off-line 10 options. As illustrated, a CTM may conduct anonymous transactions either through a distributed network such as the Internet or by off-line 10 means. The IE acts as an agent and facilitates the CTM's purchase of the good or service from the TR. FIG. 1 is intended to aid in the understanding of the description and is not intended to convey any particular hardware or software implementation. It is contemplated that an ordinarily skilled practitioner in the art could devise alternate network or software architectures to facilitate the system described herein.

Any CTM wishing to make an anonymous purchase through the IE, but who wishes to avoid use of the Internet in conducting a transaction 10, may obtain a COP from a distributor or a retail location such as a drugstore or office supply store 102, who may charge a fee for distribution of the COP. Alternatively, the CTM may obtain the COP directly from the IE; either by mail or facsimile or other equivalent means 102. Each COP contains one or more transaction media instances with the TC unique to that set of coordinated materials displayed or displayable thereon. A preferred COP comprises at least one tamper-resistant purchase form, hereinafter referred to as a CTM order form, on which the CTM can convey an offered transaction and several tamper-resistant forms that facilitate subsequent CTM and IE communications.

Because the IE transacts with the TR on behalf of the CTM, instructions from the IE caution the CTM to carefully and distinctly describe the good or service desired. The IE can elicit CTM clarity in describing the good or service on the CTM order form. It is further contemplated that the CTM will have access to TR catalogs or advertisements associated with the good or service to be purchased 101. CTMs will also learn the correct price of the good or service from the TR catalog or advertisement or from other common means, which may or may not preserve the CTM's identity depending on the CTM's desire. However, because it is possible that CTMs will offer insufficient consideration for the good or service, the CTM can indicate a maximum price or additional percentage that the IE is authorized to offer the TR for the good or service.

CTM identifying information, such as a name or any other personal information, is omitted from the CTM order form. For the purposes of this description, the CTM's identifying information is any information that would allow the IE, TR or third party to learn the identity of the CTM. Such personal information includes but is not limited to names, addresses, telephone numbers, account numbers, or the like. The CTM order form may contain information that enables the CTM to calculate the processing fees (including delivery fees) which the IE charges for its services. It is contemplated though not essential that the CTM prepay all the costs and fees for the good or service. The CTM's desired manner of the prepayment, depending on the degree of privacy desired, may be cash (for inexpensive items), postal money orders, official bank checks, authorization for debits of prepaid cash cards, and other means which provide privacy to CTM.

To protect the validity and uniqueness of the TCs, the system may include a procedure for generating unique TCs. It is preferred that the procedure for generating unique TCs results in a random TC and it is contemplated that many procedures or algorithms would be useful for generating unique TCs. Alternate embodiments also contemplate the use of a bar code or the like to generate unique bar TCs. To further reduce the likelihood that TCs are reused in COPs for other transactions, preferred system embodiments or implementations immediately remove or delete issued or generated TCs from the potential pool of TCs available for use in the future. From the described precautions, it is unlikely that a TC once selected for printing and inclusion in a COP will be used again or reassigned. Because the CTM and IE each identify and distinguish a particular transaction by the TC, knowledge of the TC would allow any third party to impersonate the CTM and redirect delivery of the good or service to other than the original or correct CTM. Accordingly, instructions with the COP caution the CTM to carefully protect against disclosure of the TC and to not reveal it—unless to a trusted agent.

Upon completion, the CTM mails the CTM order form to the IE accompanied by prepayment for merchandise and processing fees 104. Preferred system embodiments implement a concurrent, associated, or coincident communication of the TC and CTM order form from the CTM to the IE. Thus, a completed CTM order form preferably displays or includes the TC. Additional transaction media instances from the COP displaying distinguishable copies of the TC or derivations of the TC are retained by the CTM for use in subsequent communications with the IE. It is preferred that the additional transaction media instances displaying the TC be distinguishable to aid in the CTM's use of the system and method. One manner of distinguishing the transaction media instances comprises using different colors and/or by serial numbers (e.g. 1, 2, 3 . . . , etc.) that are not part of the original TC.

FIG. 1 also illustrates that CTMs may acquire a CTM order form and learn or obtain the means for generating a TC from an online IE presence 202. Although other entities could operate and administer the IE online presence, it is preferred that the IE administers its online presence such as at a website. At the IE website, a CTM will access and print or download a CTM order form and then may elect to transmit the CTM order form and TC or forms including the TC to the IE via a mail carrier such as the USPS or other off-line means for the highest level of privacy protection 204.

As illustrated in the “online” portion of FIG. 1, the CTM may navigate the website to obtain transaction media (i.e. CTM order forms) and the means for learning or generating a TC 202. In one preferred embodiment, the CTM downloads a CTM order form and the means for generating a TC rather than the actual TC. It is contemplated, though less preferred, that the website would also have means for generating TCs therein. The CTM's navigation of the website is represented by a flow diagram of the method or process. One such exemplary navigation of states is illustrated by the CTM's navigation to and from the state enabling acquisition of a CTM order form and instructions for generating a TC 202. At this state of navigation, the CTM may obtain an order form the website, which produces and/or displays a CTM order form for the CTM to download or print. Moreover, the website may also display additional options (not included in the off-line version of the CTM order form) or instructions and means for transmission of the CTM order form and for making prepayment to the IE. One manner of creating a TC comprises selecting characters randomly through a procedure supplied by the IE; and with sufficient length, the probability is infinitesimally small that a TC determined in that manner would be identical to any TC previously generated. Thus, it is preferred that the CTM order form be downloadable but that the TC instead be generated by the CTM in an “off-line” setting to reduce the possibility that a third party could monitor communications between the website and the CTM and learn the TC. An alternative embodiment allows that the procedure for generating a TC be implemented in secure software code at the website. It is contemplated that many alternate methods of generating TCs would be within the knowledge of one of ordinary skill in the art.

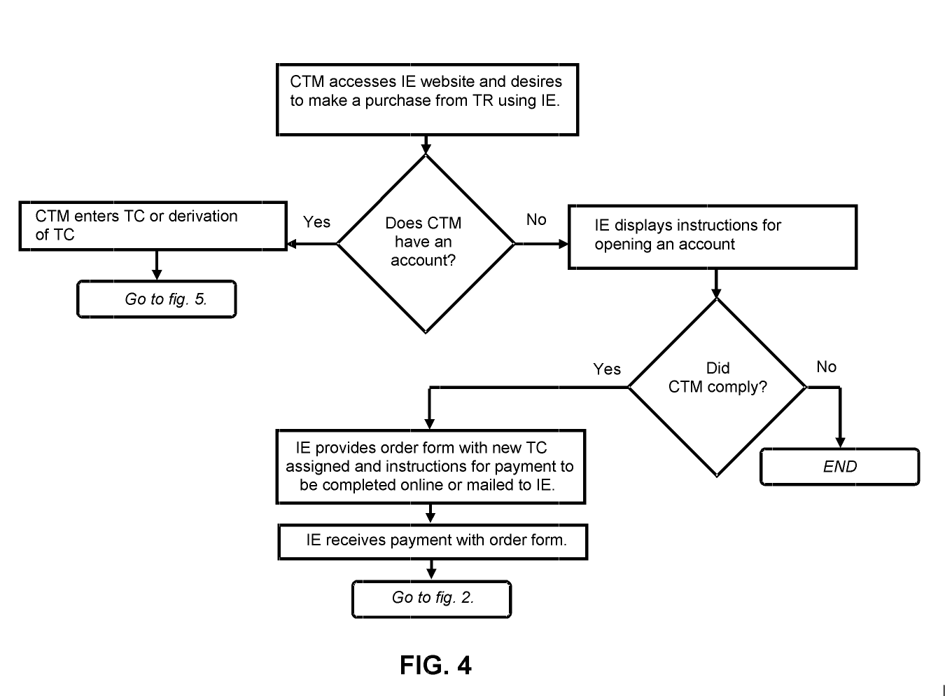

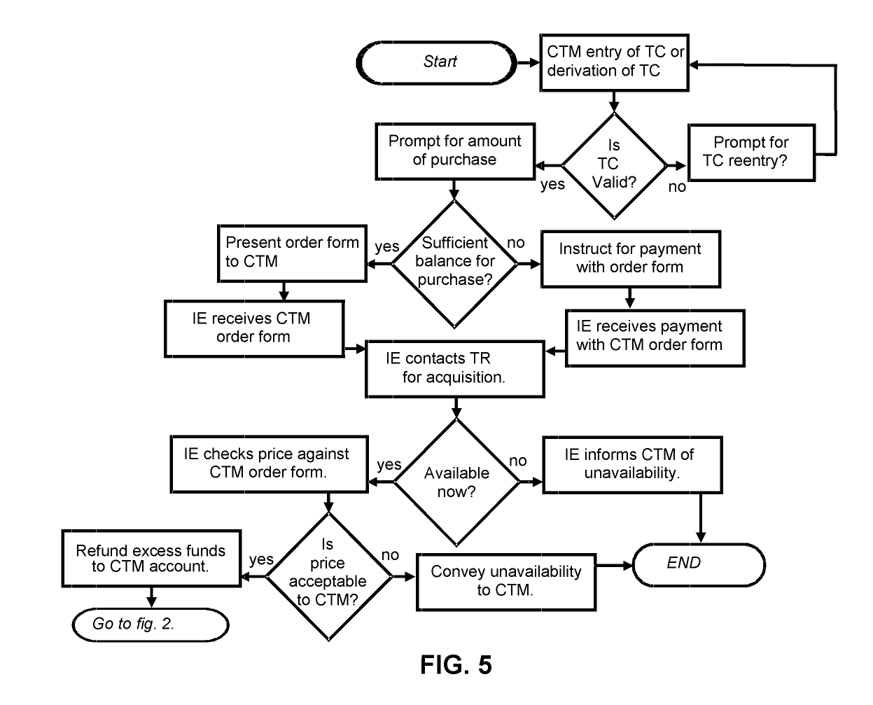

Upon completion of the form, the CTM may elect to mail the CTM order form and prepayment, or to transmit the CTM order form and/or prepayment electronically to the IE 204. If the CTM's balance is sufficient to cover the cost of the merchandise plus fees, the CTM would not need to make further payment arrangements on the CTM order form. FIG. 4 illustrates an exemplary state or flow diagram and creation of a CTM account. FIG. 5 illustrates use of the TC to check the balance of a CTM account associated with the TC. Finally, under certain circumstances initiated by the CTM and approved by the IE, a CTM may have an account balance associated with a previously established TC transferred to a new TC for subsequent transactions.

Mailing the form provides the highest level of security for the TC, as it arrives at the IE without having passed through the Internet. While the security of the TC and payment arrangements transmitted over the Internet cannot be guaranteed, CTMs may, using privacy software, reduce the probability of a security breach to a very low level that is acceptable to them. If submitting the CTM order form by mail, the CTM enters the newly generated TC on the CTM order form, supplies the desired transaction information described above, and encloses payment.

When submitting the CTM order form obtained electronically through the website, the CTM may elect to mail the prepayment, or may make payment electronically by providing an anonymous prepaid cash card number or by use of other anonymous procedures. In one embodiment, CTM accounts are transient and exist only as long as the transaction is “open” or pending. In another embodiment, CTMs may create and maintain one or more CTM accounts and associate said account(s) with one or more TCs when the CTM desires to make a transaction. Procedures for creating CTM accounts and associating said accounts with TCs are considered to be within the knowledge of one of ordinary skill in the art. Moreover, when the CTM transmits or submits a TC electronically, it is preferred for CTMs to provide an authenticating notation. Thus, when submitting a CTM order form electronically, the CTM retains a copy and enters a notation on it—only the copy, not the transmitted form—of the time and date the form was transmitted electronically. The authenticating notation can be used should a question arise concerting the validity of subsequent communications.

Upon receipt by the IE of the CTM order form accompanied by payment or authorization of payment, the IE processes the order in the same way, regardless of whether it was received electronically or through the mail 30. See FIG. 1. The IE identifies the good or service to be acquired and the intended TR and confirms that the amount of payment is correct, that the item(s) to be purchased can be legally sold through the mail or over the Internet and that the CTM order form information provided is sufficient to place the order with the TR. If any of the criteria are missing or not confirmed, the IE informs the CTM by means specified previously by the CTM on the CTM order form. Further, after receipt of the CTM order form, the IE deletes the CTM's TC from the pool of potential TCs available for use in the future; and a COP including transaction media instances with the CTM generated TC displayed is sent to CTM in accordance with CTM's instructions.

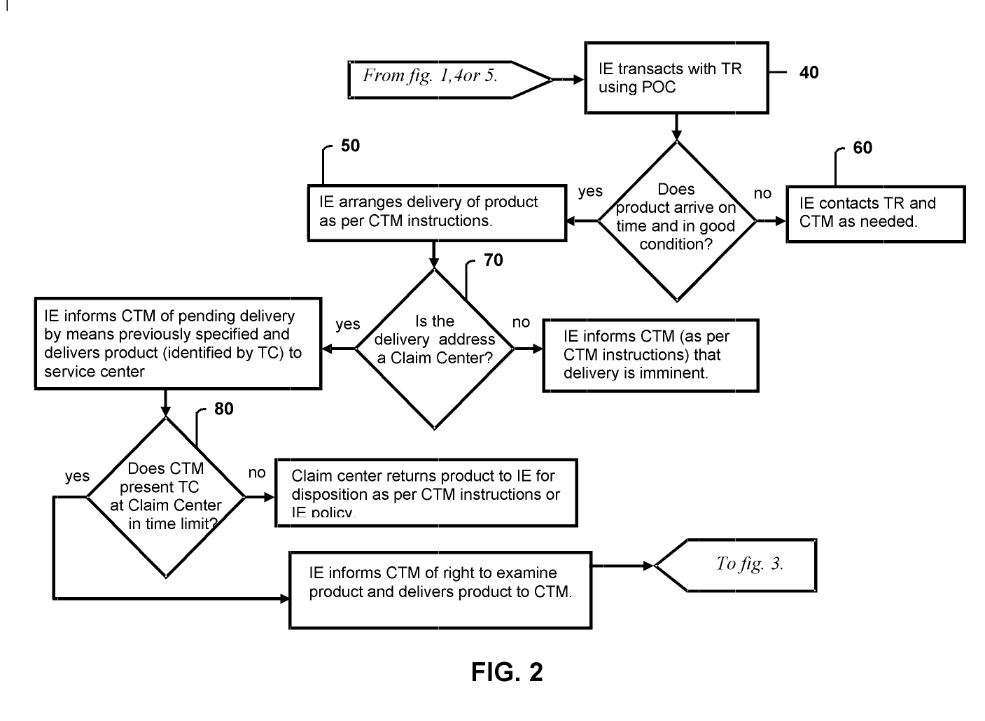

When the IE determines that the CTM order form and payment, or authorization of payment, are satisfactory, it contacts the specified TR to confirm the availability and price of the item(s) to be purchased. If both price and availability meet the CTM's specifications, the IE assigns a second unique code to the CTM's TC for that transaction. FIG. 2 illustrates an exemplary process for acquisition of the good or service by the IE from the TR. For the sake of clarity, the second unique code comprises a purchase order code and is referred to herein and in FIG. 2 as a “POC”. The IE retains the association between the CTM's TC and the POC and transacts with the TR using the POC, but not the CTM's TC 40. Further, The IE may transact with the TR in any convenient manner, however, the IE does not disclose the relationship between any TC and any POC. Thus, the TR identifies the IE as the purchaser.

In the case of goods, the TR prepares the purchased item for shipping and sends it to the IE. The purchase is identifiable to both the TR and the IE by the POC. For CTMs desiring an additional measure of anonymity, it is preferred at this point in the transaction for the IE to obscure, delete, or remove the POC from the merchandise and associate or match it with the TC to which it corresponds. The IE may also repackage the merchandise without any identification of the TR if desired by the CTM. The IE thereafter arranges delivery to the CTM in a manner previously specified by the CTM 50. Accordingly, neither the IE nor the TR knows the CTM's identity. Additionally, any observers of the repackaged merchandise are blind to the CTM's or the TR's identity.

Many transactions will be completed without the need for communications from the IE to the CTM after the IE has received the CTM's CTM order form with payment. Other transactions may require one or more additional communications between the IE and the CTM. For example, TRs may confirm availability and/or price erroneously; merchandise may be received by the IE in an unacceptable condition; and/or the CTM may have given an incorrect identification of the merchandise or paid an incorrect amount. In all such cases, the IE would communicate with the CTM by a method specified by the CTM on the CTM order form 60.

CTMs choosing to avoid Internet communications, but desiring to maintain their anonymity with respect to both the IE and the TR, may specify that the IE send letter communications through the mail to a CTM P.O. Box number or to an alias address which receives the CTM's mail. Alternately, CTMs may instruct the IE to use electronic communications such as anonymous email or prepaid phone cards or cell phones to initiate contact with the CTM and still protect anonymity to a significant degree. CTMs wishing the highest level of protection of anonymity may elect to receive communications from the IE at a previously specified local IE CTM services center 70. The CTM services center may be physically located apart from the IE facility or within a retail location such as a drugstore or office services/supply store.

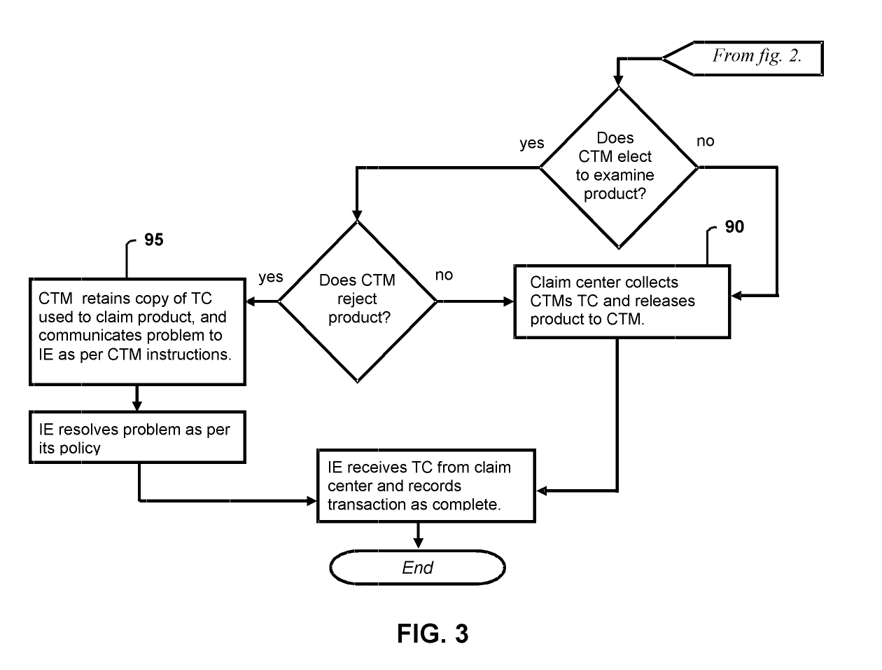

The CTM may receive messages at a CTM services center from the IE by presenting an instance of the transaction media displaying the TC. Moreover, it is preferred that the communication from the IE be contained in a sealed envelope or the like that preserves the privacy of the communication. Accordingly, the CTM service center staff person can be deterred or prevented from knowing the content of the communication. The CTM service center staff person determines whether a sealed envelope identified only by the same TC has been received from the IE. If so, the CTM exchanges its copy of the TC for the IE communication. If the message requires a reply, the CTM may use the same copy of the TC, or derivation thereof, to authenticate an immediate reply at the service center. If the message requires a reply at a subsequent time, a different copy of the transaction media bearing the same TC may be offered by the CTM. Finally, FIG. 3 illustrates how a transaction is completed and provides for acquisition of the good or service 90 or alternatively for problems with goods or services 95.

CTMs may also communicate with the IE through the IE website to facilitate a transaction. It is likely for example that different CTMs will often request the same types of information. Moreover, because it is likely that the same type of transaction related information will generally be requested by many CTMs, the IE can assign said type of transaction related information to a standard subset of transaction information and require less interaction between the CTM and the IE representative. If however the IE cannot accurately anticipate what a particular CTM wants to discuss about a particular transaction, the IE will need to provide a means of authenticating and associating CTM communications regarding a particular transaction. The embodiment described herein provides means for both predictable and unpredictable CTM initiated transaction information queries and/or communication sessions.

One preferred method of facilitating anonymous communication from the IE to its CTMs of similar types of information that qualify for the standard subset of transaction information includes using a subset of the TC to authenticate and authorize receipt of information regarding an associated or particular transaction. Further, while it is contemplated that the standard subset of transaction information will be generally accessible without the need to interact with a human representative of the IE, it is also within the scope of the description to convey the standard subset of transaction information in an interactive manner. The basic subset of information includes information that is commonly requested from an IE by a substantial number of CTMs. Thus, the basic subset of information includes, but is not necessarily limited to, purchase order status, account balance, delivery status, and basic “in-stock” or “back-order” information, and is organized in a database administered by the IE. The preferred manner of the IE communicating the basic subset of information to the CTM comprises the CTM visiting the IE website, selecting the database and, when prompted, entering a subset of the TC (e.g., a terminal subset) into a web page data-input form field. In this procedure, entering the subset of the TC simultaneously identifies the entire TC of which it is a part, and authenticates the CTM as authorized to receive information from the IE without revealing the CTM's identity. If the TC subset entered by the CTM is correct, the IE outputs or displays the basic subset of information associated with the particular TC. Similarly, the IE also may use the website to ask questions of, or initiate communications with, the CTM. For example, the IE may alert the CTM to a problem with the transaction and request that the CTM initiate communications with the IE. After confirming the validity of the TC subset entered by the CTM, the IE may require additional authentication by means of the method described in paragraph [038].

Accessing transaction information that is not predictable or less predictable generally requires interaction between the IE and the CTM, often initiated by the CTM. In a preferred embodiment, the CTM visits the IE website and indicates the desire to initiate communication. In response to an IE prompt, the CTM enters the TC or, preferably, only a subset (e.g. an initial subset). The IE then determines whether the TC or subset entered matches that of a valid TC or subset in the IE database. If the match is confirmed, the IE prompts the CTM to enter the statement or question to which the CTM wishes the IE to respond. The IE evaluates the statement or question and posts its response on the database, to be retrieved by the CTM subsequently by the method described in paragraph [036] above. In the case of CTM error, and the TC or TC subset entered does not match that of a valid TC or TC subset in the IE database, the website prompts the CTM again for the correct TC or TC subset. If the CTM fails to enter a valid TC or TC subset, the IE terminates any further communication with the CTM on that occasion. Additional alternative embodiments are also possible by which the TC divides into or comprises three or more subsets for authenticating communications.

A further enhancement of communication security comprises using an additional distinct code—an authentication code—to authenticate CTM and IE communications. The authentication code is different from the TC or TC subset(s) and used specifically to authenticate communications. One method of creating an authentication code comprises deriving said authentication code from a reference known only by the CTM and IE. One example of a reference known only by the CTM and IE comprises the CTM creation and conveyance to the IE of at least one character series preprinted on the CTM order form sent to the IE. Since only the CTM and the IE know the character series, both can subsequently authenticate communications associated with a particular transaction. Table 1 illustrates on embodiment of an exemplary character series that can be used for deriving an authentication code. The first row comprises reference numerals (e.g. 1, 2, 3 . . . 24), which identify the serial position of the alphabetic or alphanumeric characters in the character series. Thus, the first row comprises members that possess a distinct relation to the second character series, which comprises a randomly generated alphabetic or alphanumeric (the letters “O” and “I” excluded). Upon initiation of communication by the CTM using the TC or subset, the IE may use this series in instructing the CTM to create an authentication code or codes contemporaneously or prior to communications that occur after the initial exchange/communication of either the CTM order form or the TC.

To create an authentication code, the IE instructs the CTM to construct or derive at least one alternative authentication code from the character series prior to or contemporaneously with a communication. It is preferred that the authentication code(s) changes for each subsequent communication between a CTM and an IE. One manner of constructing alternative authentication codes comprises the selection of subsets of the series. Thus, the IE may first confirm the communication of a correct initial TC subset and then instruct the CTM to select and communicate an authentication code subset. For example, the IE may instruct that the 1st, 4th, 5th, and 20th characters of the series represent a subset. The CTM entry of “P”, “H”, “N”, and “D”, is the authentication code for that instance of CTM communication. The IE then confirms that the CTM has entered the correct authentication code, and deletes that authentication code from any future use in that or any other transaction. If the CTM enters an incorrect authentication code, the IE will prompt the CTM for reentry.

Finally, the IE terminates communication if it is finally unable to confirm an authentication code or codes. The IE also records the apparent fraudulent attempt to use the TC or subset for further evaluation and possible action by its security staff. Thus, the use of the authentication code or codes may aid in the detection of improper use or disclosure of TCs. Further, were a third party to obtain the CTM's initial subset (or even the entire TC), and/or observe an instance of an authentication code as it is being entered, keystroke-by-keystroke, he or she cannot use it to communicate with the IE in order to initiate a fraudulent instruction because no specific instance of the authentication code described in this section can ever be repeated. Only if such third party were to obtain the CTM's copy of the CTM order form sent to the IE would it be able to represent itself falsely as the CTM to the IE.

CTMs electing to send their purchase orders to the IE using the mail may choose to send and receive subsequent communications through the website, others will prefer to restrict all communications to off-line channels or means. The messages the CTM wishes to direct to the IE may consist of answers to questions asked by the IE, or questions posed from the CTM for the IE to answer (e.g., “Will the TR guarantee that the damaged merchandise will be replaced in 30 days?”), or statements of fact or opinion that are not responses to questions (e.g., “We were amazed and very pleased by the speed with which the merchandise we ordered was delivered.”

CTMs obtaining a COP will have in their possession copies of the TC that are useful for authenticating messages from the CTM to the IE. To send a message to the IE, the CTM simply writes out the message, places it an envelope with no identification other than the TC, and mails it to the IE. Upon receipt, the IE determines whether the TC is a valid (i.e. in the database), and responds in the manner specified, e.g., a letter addressed to a P.O. box number. Likewise, the CTM may initiate communications and the IE may authenticate messages for Internet or online communications using authentication codes as previously described.

Even if the CTM fails to follow the IE guidelines, and a third party knows the CTM's identity or obtains the full TC, that information would still not enable the third party to obtain the object of the transaction (i.e. good or service) either from a CTM services center or a delivery agent. In preferred embodiments, the CTM surrenders the appropriate printed copy on tamper resistant paper of the TC to receive the good or service at a CTM services center, or sign for it should the merchandise be delivered by USPS, FedEx, or a similar entity. The third party cannot, through penetration of CTM's computer files, retrieve an authentic hard copy of the TC, and could not plausibly manufacture one that successfully mimicked the tamper-resistant paper used for authentic TCs. Nor is it plausible that a third party could appear at the street address or behind the post office counter to sign for a package delivered by USPS, FedEx, or other delivery agent. Thus, the system remains fraud resistant even if there is a disclosure of CTM identifying information.

Finally, it is preferred that the IE deletes or destroys all information or files pertaining to a completed transaction. Thus, unless restricted by law, the IE removes transaction information upon confirmation of the CTM's receipt of the good or service and waiver of the right to future claims against the IE or the TR concerning the transactions associated with that good or service.

The system and method described herein can also be used to sell items anonymously. The system provides anonymity for both the CTM/buyer and the CTM/seller. The CTM previously described above may be a buyer or a seller subject to differences described below. For the purposes of describing this embodiment the CTM/buyer is referred to as the “buyer” and the CTM/seller the “seller.” In this embodiment the seller obtains a TC in the same manner as described above for making purchases and completes the CTM order form with the description of an invitation to receive offers. The seller may describe a price, condition of the good, and other information about the good or service to be sold. The CTM order form, accompanied by payment of fees of the IE, is then transmitted to the IE. Upon receipt of the CTM order form, the IE confirms that the amount of payment is correct, that the item(s) to be sold can be legally sold over the Internet, and that the information provided is sufficient for the IE to include the item(s) on its list of merchandise for sale, which can be accessed on the website.

Potential buyers may direct requests for additional information through the IE to the CTM/seller, identified to the buyer only by the POC for the item(s) for sale. Such requests are communicated to the seller by the IE in the manner previously specified by the seller, and the IE responds to buyer in the manner stipulated by the buyer. The buyer may make its identity known to the IE and the seller from the outset; may withhold it until a purchase/sale agreement is reached but not executed, then reveal it; or may withhold it throughout. If the buyer elects to maintain anonymity, either temporarily or throughout the transaction, it will buy a TC and transmit a CTM order form in the manner described above.

Upon the IE's receipt of the executed purchase/sale agreement and payment from buyer of the full price of the merchandise plus any fees, the IE provides CTM with shipping instructions by which seller arranges delivery to the IE. Depending on the conditions of the purchase/sale agreement, the IE may (1) obscure or remove any information identifying the seller from the packaging and arrange for delivery to buyer, or (2) may first establish an escrow process in which the seller and buyer agree that no funds will be disbursed to the seller, and that the merchandise will not be released to buyer, until inspection and acceptance by the buyer of the merchandise.

Following buyer's acceptance of the delivered merchandise, the IE forwards buyer's payment to the seller and the transaction is completed. If buyer refuses delivery, either as a consequence of inspection while the transaction is in escrow or because of damage in shipment or other reason, the IE returns the merchandise to the seller and refunds the purchase price to buyer, less any fees due the IE from buyer or seller.

The system and method described herein is also useful for delivering items such as gifts, letters, or documents in an anonymous manner. In this regard, it is unnecessary that a transaction for consideration occur but merely a conveyance from one party to another. In an exemplary embodiment, after obtaining a TC in the manner described above, the CTM/transferor (hereinafter “transferor”) completes the CTM order form, describing the item(s) to be delivered, the name and address of the recipient or transferee, and the method of delivery. Upon receipt of the CTM order form accompanied by payment of the IE's fees, the IE confirms that the amount of payment is correct and that the item(s) to be delivered meet legal requirements and the IE's policies. If the item(s) to be delivered are not acceptable to the IE, the transferor is so advised by means previously specified, and all or a portion of the IE fee is returned. If the item(s) are acceptable, the IE provides the transferor with shipping instructions by which the transferor arranges delivery to the IE. Following confirmation by the IE of the acceptability of the item(s), the IE arranges delivery to recipient in the manner specified by the transferor. It is also contemplated that the transferee may also place conditions upon receipt of the good and may instruct on means for delivery.

Although the invention has been described in detail with reference to one or more particular preferred embodiments, persons possessing ordinary skill in the art to which this invention pertains will appreciate that various modifications and enhancements may be made without departing from the spirit and scope of the claims that follow.

TABLE 1

| 1 | 2 | 3 | 4 | 5 | 6 | 7 | 8 | 9 | 10 | 11 | 12 | 13 | 14 | 15 | 16 | 17 | 18 | 19 | 20 | 21 | 22 | 23 | 24 |
|---|---|---|---|---|---|---|---|---|---|---|---|---|---|---|---|---|---|---|---|---|---|---|---|
| P | X | Z | H | N | C | F | C | A | V | M | F | Q | B | R | T | T | G | J | D | B | L | N | S |

1. A method for facilitating a transaction between an anonymous customer and a transferor using an intermediate entity, comprising:
the intermediate entity, using a first unique code to authenticate and communicate terms of the transaction between the anonymous customer and the intermediate entity;
the intermediate entity, associating the first unique code with a second unique code and transacting with the transferor using the second unique code to obtain a good or service according to the terms communicated by the customer and without revealing a customer's identifying information or the first unique code; and
delivering the good or service as instructed by the customer.

2. The method in claim 1 wherein,
the terms communicated are selected from the group consisting of; a transferor identity, a description of the good or service, a price to be paid for the good or service, and a desired manner of delivery to the customer.

3. The method in claim 1 wherein,
the independent entity receives the good or service from the transferor and obscures the second unique code before delivering the good or service to the customer.

4. The method in claim 1 wherein,
the first unique code accompanies a first communication from the customer to the independent entity and derivations of the first unique code authenticate subsequent communications between the customer and the independent entity.

5. The method in claim 1 wherein,
the customer receives the good or service by communicating the first unique code at a customer service center.

6. The method in claim 1 further comprising,
authenticating communications that occur subsequent to the communication of terms of the transaction between the anonymous customer and the intermediate entity, by verifying a third unique code derived from a reference known previously by the customer and the independent entity.

7. The method of claim 1 wherein,
the customer is selected from the group consisting of; buyers, sellers, merchants, vendors, gift givers, transferors and transferees.

8. The method of claim 1 wherein,
the transferor is selected from the group consisting of; buyers, sellers, merchants, vendors, gift givers, transferors and transferees.

9. A system for conducting a transaction between a customer and a transferor for a good or service, comprising:
a transaction media that includes a transaction code that is used by the customer to communicate terms of the transaction and identify the transferor, but that omits customer identifying information; and
an intermediate entity that; associates the transaction code with a purchase order code and processes the transaction for the customer, and neither the transaction code nor the association between the purchase order code and the transaction code is disclosed to the transferor; and that conveys the good or service to the customer.

10. (canceled)

11. (canceled)

12. (canceled)

13. (canceled)

14. (canceled)

15. A computer system for conducting transactions between a plurality of customers and a plurality of transferors for goods or services, comprising:
at least one database stored on a computer readable medium, comprising a plurality of account identifiers, each account identifier associated with a first unique code that is without any customer identifying information but which is used to specify the good or service to be exchanged for value and associated with only one of the plurality of transactions, a plurality of second unique codes without any customer identifying information and each of which is associated with one first unique code, and used by an intermediate entity to identify transactions with a transferor on behalf of one of the plurality of customers, a generation and display of transaction related messages retrievable by and associated with the first unique code; and
an input for administering the database and associating the accounts with the first and second unique codes.

16. The computer system in claim 15 further comprising,
a physical location administered by the intermediate entity where the plurality of customers can receive the good or service or communications regarding the good or service.

17. The computer system in claim 15 wherein,
the transaction media comprises a form that is filled by the customer and the first unique code is displayed on a separate form, both forms included in a tamper resistant packet.

18. The computer system in claim 15 further comprising,
a first authenticating code derived from the first unique code and which is communicated by the customer to the intermediate entity, which-uses the first authenticating code to authenticate communications.

19. The system in claim 18 further comprising,
a second authenticating code derived from the first unique code to authenticate customer permission to receive communications regarding a transaction from the intermediate entity, the communications regarding a transaction selected from the group consisting of; purchase order status, account balance, delivery status, and basic “in-stock” or “back-order” information.

20. The computer system in claim 18 further comprising,
a second authenticating code derived from a reference originally communicated by the intermediate entity to the customer, the second authenticating code derived prior to a subsequent communication between the customer and intermediate entity but after the customer initially communicates terms of the transaction to the intermediate entity.

21. The computer system in claim 15 further comprising,
an input accessible by the plurality of customers over a distributed network that permits the customers to open an account but omit the conveyance of customer identifying information.

22. A method for facilitating a plurality of transactions between a plurality of customers and a plurality of transferors, comprising:
creating a database comprising a plurality of accounts, wherein each account is associated with a first unique code that is without information related to the identity of any customer and associated with only one of the plurality of transactions, a plurality of second unique codes each of which is associated with one first unique code,
communicating with and modifying the database by associating each of the plurality of transactions with one of the accounts and with a first unique code;
communicating over a distributed network the terms of the transaction to the customer using the first unique code;
transacting on behalf of the customer with the transferor using the second unique code to obtain a good or service; and
delivering the good or service to the customer.

23. The method in claim 22 wherein,
the terms communicated are selected from the group consisting of; a transferor identity, a description of the good or service, a price to be paid for the good or service, and a desired manner of delivery to the customer.

24. The method in claim 22 wherein,
an independent entity receives the good or service from the transferor and obscures the second unique code before delivering the good or service to the customer.

25. The method in claim 22 wherein,
the first unique code accompanies a first communication from the customer to the independent entity and derivations of the first unique code authenticate subsequent communications between the customer and the independent entity.

26. The method in claim 22 wherein,
the customer receives the good or service by communicating the first unique code at a customer service center.

27. The method in claim 22 further comprising,
authenticating communications that occur subsequent to the communication of terms of the transaction between the anonymous customer and the intermediate entity, by verifying a third unique code derived from a reference known previously by the customer and the independent entity.

28. The method in claim 27 wherein,
the third unique code is derived from the first unique code.

29. The method of claim 22 wherein,
the customer is selected from the group consisting of; buyers, sellers, merchants, vendors, gift givers, transferors and transferees.

30. The method of claim 22 wherein,
the transferor is selected from the group consisting of; buyers, sellers, merchants, vendors, gift givers, transferors and transferees.

31. The method in claim 22 wherein,
communicating with and modifying the database comprises the plurality of customers accessing the database over a distributed network.

32. The method in claim 22 wherein,
communicating with and modifying the database comprises an intermediate entity communicating with and modifying the database.
